(19) United States
(12) Patent Application Publication
(10) Pub. No.: US 2010/0289243 A1
(43) Pub. Date: Nov. 18, 2010

(54) Mudguard for Mobile Working Machines

(76) Inventors: Matthias Hausmann, Stuttgart (DE); Dieter Schneider, Filderstadt (DE); Joachim Leibbrand, Engelsbrand (DE)

Correspondence Address: COLLARD & ROE, P.C., 1077 NORTHERN BOULEVARD, ROSLYN, NY, 11576, US

(21) Appl. No.: 12/225,345

(22) PCT Filed: Mar. 14, 2007
(86) PCT No.: PCT/EP2007/002230

§ 371 Date: Sep. 19, 2008

(30) Foreign Application Priority Data
Apr. 15, 2006 (DE) 10 2006 017 766.5

(51) Int. Cl. B62D 25/18

(52) U.S. Cl. 280/154; 280/848

(57) ABSTRACT

The invention relates to a mudguard (38) for motor vehicles, in particular for mobile concrete pumps. The mudguard (38) has a dirt trap (42) which partially extends over the running surfaces of wheels of the mobile working machine, and fastening means (40) for fixing the dirt trap to a point on the working machine which is fixed to the chassis. According to the invention, the mudguard (38) is in the form of a plastic self-supporting hollow chamber component which has a dirt trap part (42) and a flange part (44) which is integrally connected to said dirt trap part, wherein the flange part (44) has a plurality of transverse apertures (46), which are arranged in a grid-like fashion in relation to one another, for holding the fixing means (40).

### SPECIFICATION

The invention relates to a mudguard for motor vehicles, particularly for mobile working machines, having a dirt catcher that partly covers the running surfaces of wheels, and having attachment means for fixing the dirt catcher in place on a location of the working machine that is fixed on the chassis.

Mudguards of this type stated initially are particularly intended for mobile concrete pumps, pump mixers, and mobile conveyor belts that are mounted on truck chassis. In the case of mobile working machines, important aspects are, in particular, ease of installation, weight, the surface treatment, and corrosion behavior. Known mudguards of this type predominantly consist of sheet aluminum. They are structured as complicated welded constructions, which require complex surface coating with powder priming and a subsequent varnishing process. In addition, there is the not insignificant installation effort on the chassis.

Proceeding from this, the invention is based on the task of developing a mudguard of the type indicated initially, which is characterized by low weight and by relatively little effort in production and installation.

To accomplish this task, the combination of characteristics indicated in claim 1 is proposed. Advantageous embodiments and further developments of the invention result from the dependent claims.

The solution according to the invention is essentially seen as being that the mudguard is configured as a self-supporting hollow-chamber component made of plastic, which has a dirt catcher part and a flange part connected with it in one piece, whereby the flange part has multiple crosswise perforations disposed in raster-like manner relative to one another. It is advantageous if the crosswise perforations are configured as hollow crosspieces that extend between two hollow-chamber walls that are parallel to one another. In order to allow easier installation and equalization of tolerances, it is practical if the crosswise perforations are configured in the manner of an oblong hole, in their outline. Fundamentally, it is possible that the flange part is configured to be solid in the region of the crosswise perforations.

A preferred embodiment of the invention provides that the flange part has an essentially rectangular installation surface, through which the crosswise perforations penetrate, and that the dirt catcher part follows the flange part at a longitudinal edge, and is angled away, relative to it, at an obtuse or right angle, whereby the flange part and the dirt catcher part are reinforced on their underside, with rib chambers that extend beyond the longitudinal edge and are formed into the hollow-chamber component, doming out towards the underside. Using these measures, it is possible to absorb great bending forces between the flange part and the dirt catcher part, without the risk of breakage. To further increase the shape stability, according to a preferred embodiment of the invention, the flange part and/or the dirt catcher part are provided with edge chambers on their outer edges, projecting towards the underside, in each instance, formed into the hollow-chamber component. In addition, reinforcement beads can be formed into the upper delimitation walls of the flange part and/or of the dirt catcher part.

In order to allow stable and breakage-safe installation, the attachment means have at least one pressure plate equipped with spacer sleeves, whereby the spacer sleeves pass through at least one part of the crosswise perforations situated in the flange part, in the fixed state, pressing the pressure plate against the flange part, and are fixed in place on the chassis by means of threaded pins and threaded nuts. To achieve an additional shape fit, it is practical if the flange plate, on its underside, has recesses formed into the related hollow-chamber delimitation wall, adapted to the contour of the pressure plates, whereby the crosswise perforations penetrate the lower hollow-chamber delimitation wall in the region of the recesses.

According to a further advantageous embodiment of the invention, threaded inserts for attaching a mud flap are let into an edge zone of the dirt catcher part.

The invention furthermore relates to a mobile working machine, particularly a mobile concrete pump, having a chassis and platforms affixed to the chassis, whereby the platforms consist of hollow-profile rails that have undercut longitudinal grooves, open towards the bottom, for accommodating T-nuts provided with threaded bores or pins (EP 1 355 820 B1). It is advantageous if the mudguards according to the invention are connected with the threaded bores or pins of the T-nuts disposed in the longitudinal grooves, with their attachment means. In this case, installation of the mudguards proves to be particularly simple. It is possible to use existing attachment means in the region of the hollow-profile platforms of the working machine.

The measures according to the invention ensure that the mudguards can be used as standard components of mobile working machines, which are optimized with regard to standardization, modularity, production and installation effort, ease of installation, weight, surface treatment, corrosion behavior, and design. The mudguards, which consist of solid-color plastic, do not require any kind of surface treatment. The prepared crosswise perforations in the flange parts, which are configured as oblong holes, allow position-precise installation. When using similar hollow-profile platforms on different types of working machines, the same mudguards can be used on different machine models. In this way, a high degree of standardization is obtained, with the lowest possible inventory.

In order to allow right-side and left-side installation of the mudguards, the flange part and the dirt catcher part are structured with mirror symmetry with reference to a vertical center plane.

In the following, the invention will be explained in greater detail using an exemplary embodiment shown schematically in the drawing. This shows:

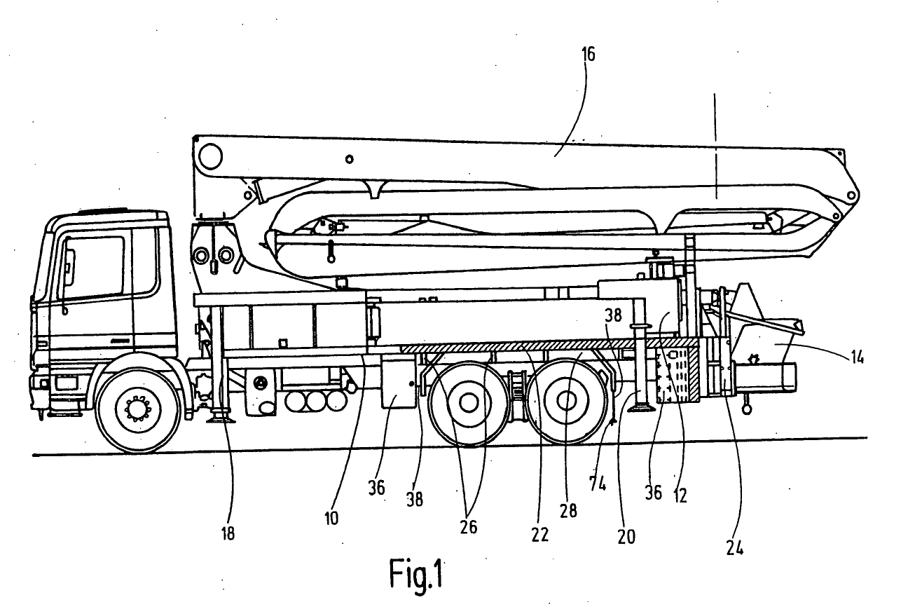

FIG. 1 a side view of a working machine, having a hollow chamber profile platform and mudguards set onto it;

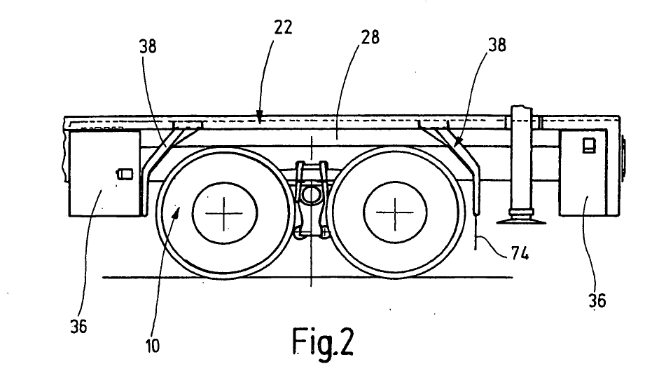

FIG. 2 an enlarged detail from FIG. 1, from the region of the rear axle;

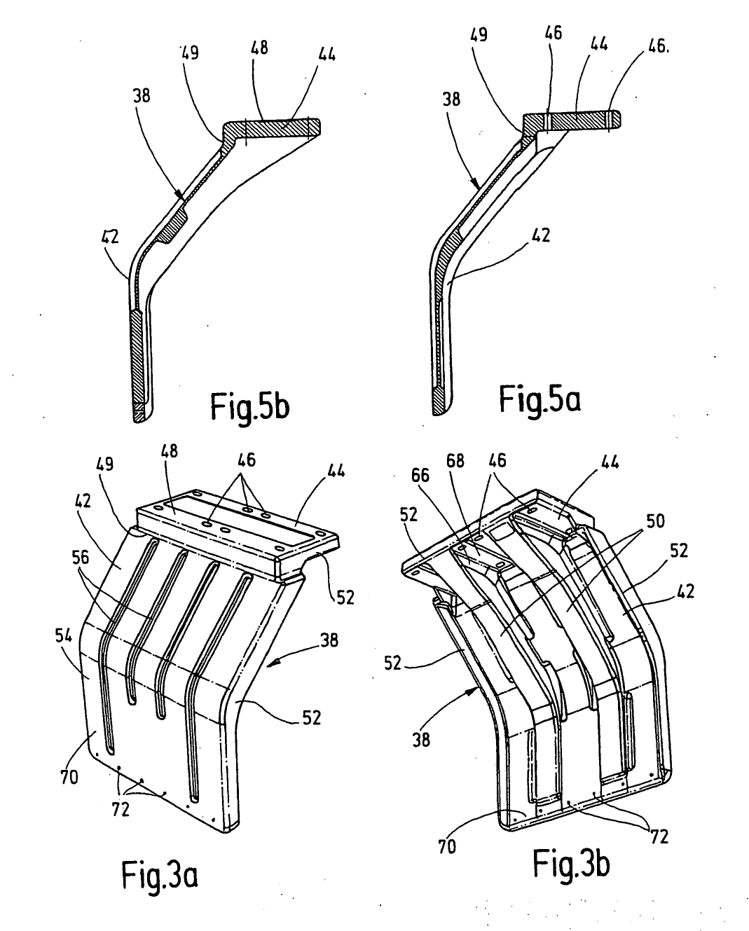

FIG. 3a and b a top view and a bottom view of the mudguard, in a schematic representation, in each instance;

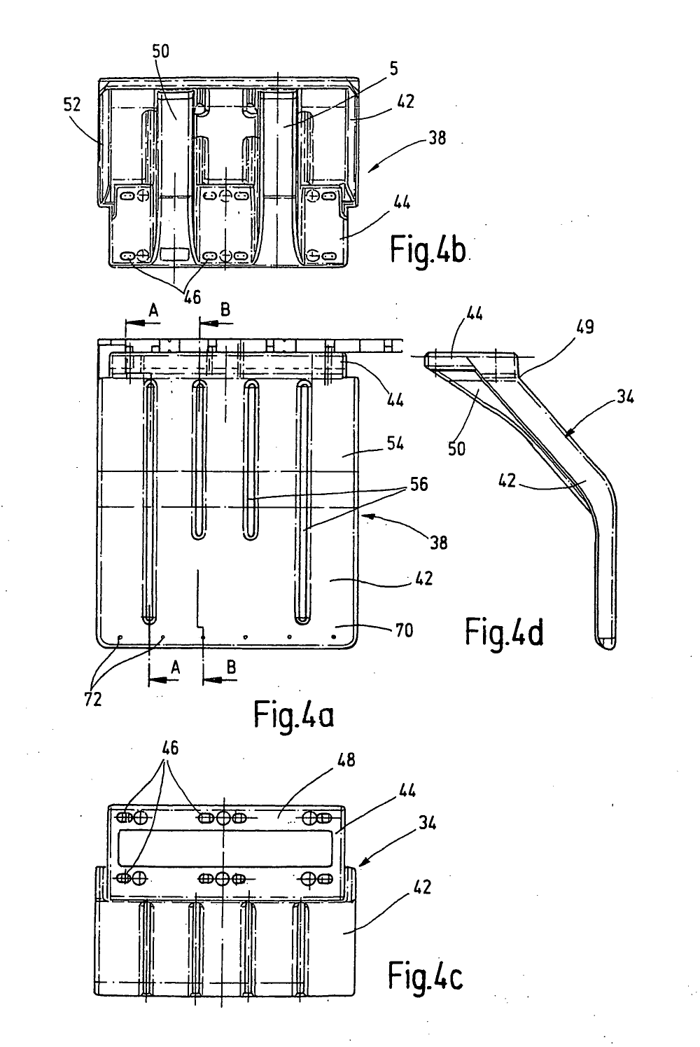

FIG. 4a to d a broad-side view, a bottom view, a top view, and a narrow-side view of the mudguard according to FIGS. 3a and 3b;

FIG. 5a and b sections along the section lines A-A and B-B of FIG. 4a;

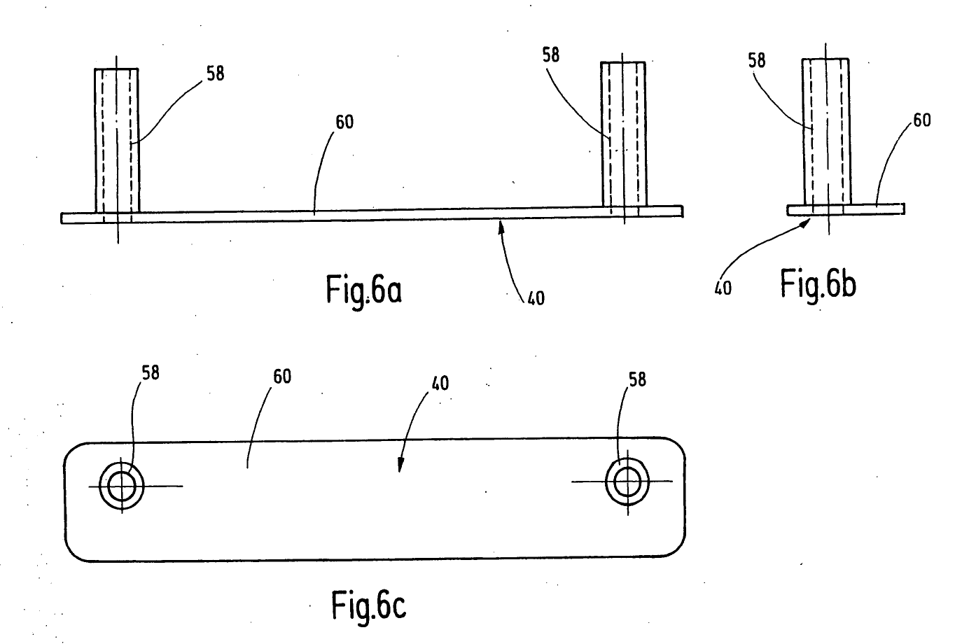

FIG. 6a to c a broad-side view, a narrow-side view, and a top view of an attachment plate equipped with spacers, as an attachment means for the mudguard; and

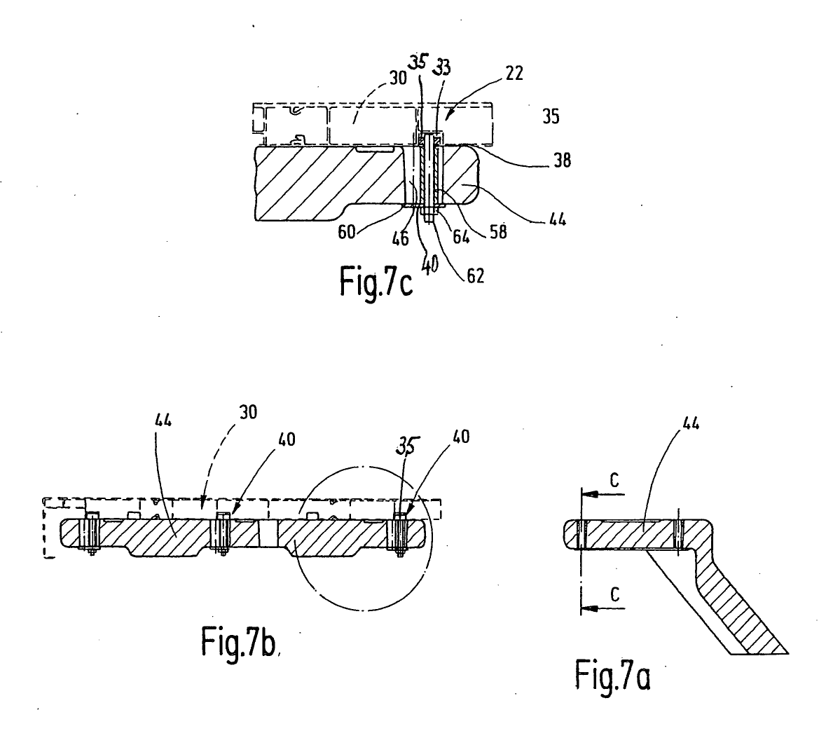

FIG. 7a to c two sections, perpendicular to one another, through the attachment flange, as well as an enlarged detail from FIG. 7b, with the attachment means inserted.

In the drawing, the mudguards according to the invention are shown for the example of a mobile concrete pump. The mobile concrete pump shown in FIG. 1 has a chassis 10, a thick-substance pump 12 disposed on the chassis, having material application container 14 and distributor mast 16, front and rear support legs 18, 20, which can extend from the chassis, two platforms 22 disposed on the chassis laterally next to the thick-substance pump 12 and the distributor mast 16, as well as a rear set of steps 24 that leads up to the platforms. The platforms 22 rest on support brackets 26, which are welded onto related longitudinal supports 28 of a support frame affixed to the chassis, at a distance from one another, and project laterally beyond them. The platforms 22 consist of hollow-profile rails 30, which are fitted out with undercut longitudinal grooves 33, open towards the bottom, for accommodating T-nuts 35 provided with threaded bores or pins. The T-nuts 35 can be positioned at any desired locations of the longitudinal grooves. The T-nuts 35 situated in the longitudinal grooves 33 are used, for one thing, to fix the hollow-profile rails 30 that form the platforms in place on the support brackets 26. For another thing, accessory parts 36, such as toolboxes, hoppers, or the like, can also be fixed in place from below, by means of screws, by way of the longitudinal grooves 33 and the T-nuts 35. The hollow chambers in the hollow-profiles rails 30 are furthermore suitable for accommodating lines, particularly electrical and pneumatic or hydraulic lines, which must be laid along the chassis of the mobile concrete pump.

In the case of the exemplary embodiment shown in the drawing, the mudguards 38 are furthermore fixed in place on the hollow-profile rails 30 with attachment means 40 and the T-nuts 35 (cf. FIGS. 2 and 4a).

The mudguard 38 shown in FIGS. 3 to 7 is configured as a self-supporting hollow-chamber component made of plastic, preferably of polyethylene, and it is practical if it is produced using the rotation method. The hollow-chamber component has a dirt catcher part 42 and a flange part 44 connected in one piece with it. The flange part 44 has multiple crosswise perforations 46 disposed in raster-like manner, extended in the manner of oblong holes, which penetrate the flange part crosswise and which can be configured, for example, as hollow crosspieces that extend between two hollow-chamber walls that are parallel to one another. In FIGS. 5a and 7a to c, it is indicated that the flange part can be configured to be solid in the region of the crosswise perforations. As can particularly be seen in FIGS. 3a and 4c, the flange part 44 has an essentially rectangular installation surface 48, through which the crosswise perforations 46 penetrate, while the dirt catcher part 42 follows the flange part 44 at a longitudinal edge 49, and is angled away, relative to it, at an obtuse angle (FIG. 4d, 5a and b). The flange part 44 and the dirt catcher part 42 are reinforced on their underside, with rib chambers 50 that extend beyond the longitudinal edge 49 and are formed into the hollow-chamber component, doming out towards the underside. For further reinforcement, the flange part 44 and the dirt catcher part 42 have edge chambers 52 formed into the hollow-chamber component, as well as reinforcement beads 56 formed into the upper delimitation wall 54 of the dirt catcher part. In order to allow both right-side and left-side installation, the mudguard is structured with mirror symmetry with reference to a vertical center plane (cf. FIG. 3a and b).

To fix the mudguard in place on the hollow-profile rails 30 of the platforms 22, attachment means 40 are provided, which, according to FIG. 6a to c, have a pressure plate 60 having two spacer sleeves 58, disposed at a distance from one another. In the fixed state, the spacer sleeves 58 pass through two adjacent crosswise perforations 46 of the flange part 44, and are screwed to the longitudinal grooves 33 of the platform 22 by means of threaded pins 62 and stop nuts 64, by way of the T-nuts 35. In order to secure the pressure plates 60 on the mudguard, to prevent lateral shifting, depressions 68 are formed into the lower hollow-chamber delimitation wall 66 of the flange part 44, which are adapted to the outer contour of the pressure plates 60.

Multiple threaded inserts 72, disposed in a row, which are intended for fixing a mud flap 74 in place, are let into a lower edge zone 70 of the dirt catcher part (FIG. 3b and FIG. 2).

In summary, the following should be stated: The invention relates to a mudguard 38 for motor vehicles, particularly for mobile concrete pumps. The mudguard 38 has a dirt catcher 42 that partly covers the running surfaces of wheels of the mobile working machine, as well as attachment means 40 for fixing the dirt catcher in place on a location of the working machine that is fixed on the chassis. According to the invention, the mudguard 38 is configured as a self-supporting hollow-chamber component made of plastic, which has a dirt catcher part 42 and a flange part 44 connected with it in one piece, whereby the flange part 44 has multiple crosswise perforations 46 disposed in raster-like manner, for accommodating the attachment means 40.

1. Mudguard for motor vehicles, particularly for mobile working machines, having a dirt catcher that partly covers the running surfaces of wheels, configured as a self-supporting hollow-chamber component made of plastic, and having attachment means (40) for fixing the dirt catcher in place on a location of the working machine that is fixed on the chassis, whereby the hollow-chamber component has a dirt catcher part (42) and a flange part (44) connected with it in one piece, wherein the flange part (44) has an essentially rectangular installation surface (47), through which crosswise perforations (46) disposed in raster-like manner penetrate, wherein the dirt catcher part (42) follows the flange part (44) at a longitudinal edge (49), and is angled away, relative to it, at an obtuse or right angle, and wherein the flange part (44) and the dirt catcher part (42) are reinforced on their underside, with rib chambers (50) that extend beyond the longitudinal edge and are formed into the hollow-chamber component, doming out towards the underside.

2. Mudguard according to claim 1, wherein the flange part (44) is configured to be solid in the region of the crosswise perforations (46).

3. Mudguard according to claim 1, wherein the crosswise perforations (46) are configured as hollow crosspieces that extend between hollow chamber walls that run parallel to one another.

4. (canceled)

5. Mudguard according to claim 1, wherein the flange part (44) and/or the dirt catcher part (42) have edge chambers (52) on their outer edges, projecting towards the underside, in each instance, formed into the hollow-chamber component.

6. Mudguard according to claim 1, wherein reinforcement beads (56) are formed into the upper delimitation wall (54) of the flange part and/or of the dirt catcher part (42).

7. Mudguard according to claim 1, wherein the attachment means (40) have a pressure plate (60) equipped with at least one spacer sleeve (58), in each instance, and that the at least one spacer sleeve pass through at least one part of the crosswise perforations situated in the flange part (44), in the fixed state, pressing the pressure plate (60) against the flange part (44), and are fixed in place on the chassis using threaded means (64).

8. Mudguard according to claim 14, wherein the pressure plate (60) is equipped with two spacer sleeves (58) disposed at a distance from one another and oriented parallel.

9. Mudguard according to claim 14, wherein the flange part (44), on its underside, has depressions (68) formed into the hollow-chamber delimitation wall (66) there, adapted to the contour of the pressure plates (60).

10. Mudguard according to claim 9, wherein the crosswise perforations (46) penetrate the lower hollow-chamber delimitation wall (66) in the region of the depressions (68).

11. Mudguard according to claim 1, wherein threaded inserts (72) for attaching a mud flap (74) are let into an edge zone (70) of the dirt catcher part (42).

12. Mudguard according to claim 1, wherein the flange part (44) and the dirt catcher part (42) are structured with mirror symmetry with reference to a vertical center plane.

13. Motor vehicle, particularly a mobile working machine, having a chassis (10) and platforms (22) resting on support brackets (26), which platforms project laterally from the chassis (10) and on which it is possible to walk, whereby the platforms (22) consist of hollow-profile rails (30) that have undercut longitudinal grooves (33), open towards the bottom, for accommodating T-nuts (35) provided with threaded bores or pins, wherein the mudguards according to claim 1 are rigidly connected with the T-nuts (35) disposed in the longitudinal grooves (33), with their attachment means (40), by means of threaded pins (62) that pass through spacer sleeves (58).

14. Mudguard for motor vehicles, particularly for mobile working machines, having a dirt catcher that partly covers the running surfaces of wheels, configured as a self-supporting hollow-chamber component made of plastic, and having attachment means (40) for fixing the dirt catcher in place on a location of the working machine that is fixed on the chassis, whereby the hollow-chamber component has a dirt catcher part (42) and a flange part (44) connected with it in one piece, wherein the flange part (44) has multiple crosswise perforations (46) disposed in raster-like manner, wherein the attachment means (40) have a pressure plate (60) equipped with at least one spacer sleeve (58), in each instance, and wherein the at least one spacer sleeve pass through at least one part of the perforations situated in the flange part (44), in the fixed state, pressing the pressure plate (60) against the flange part (44), and are fixed in place on the chassis using threaded means (64).
